(19) United States
(12) Patent Application Publication
(10) Pub. No.: US 2017/0188562 A1
(43) Pub. Date: Jul. 6, 2017

(54) QUICK RELEASE FISHING ASSEMBLY

(71) Applicant: Taylor Liverance Olson, LLC, 122 Lyford Place, SC (US)

(72) Inventors: Ross L. TAYLOR, Beaufort, SC (US); Michael C. LIVERANCE, Plano, TX (US); Erik L. OLSON, Bluffton, SC (US); Thomas LOOPER, Easley, SC (US); Hunter PELHAM, Ladson, SC (US); Jacob SUITS, Moore, SC (US); Dylan TYNER, Wichita, KS (US); Jessica ANRAKU, Dublin, OH (US); Alexis Berry, Chapin, SC (US); Clayton BRZEZINSKI, Charlotte, NC (US); Jeffrey GIEZEN, Charlotte, NC (US)

(21) Appl. No.: 15/325,170

(22) PCT Filed: Jul. 8, 2015
(86) PCT No.: PCT/US15/39575

§ 371 Date: Jan. 10, 2017

Related U.S. Application Data
(60) Provisional application No. 62/023,040, filed on Jul. 10, 2014.

(51) Int. Cl. A01K 91/04; A01K 85/02

(52) U.S. Cl. CPC A01K 91/04; A01K 85/02

(57) ABSTRACT

Certain embodiments of the present disclosure are directed to quick release fishing assemblies providing improved performance in ease of handling and mitigation of inadvertent disengagements.

### FIELD OF THE DISCLOSURE

The present disclosure relates to fishing assemblies, and more particularly to, quick release fishing assemblies.

### RELATED ART

Anglers typically attach a fishing lure to an end of a fishing line extending from a fishing rod and reel. The fishing lure is equipped with one more hooks that are used to hook the fish when it attacks the lure.

In traditional fishing assemblies, a common fishing swivel usually connects the fishing line and the fishing lure. Use of a traditional swivel has disadvantages, particularly in limiting the ability for the angler to safely bring a hooked fish into the boat.

It has been proposed to incorporate a quick release assembly into a fishing assembly to replace the need of a swivel and improve the speed and efficiency of changing out lure assemblies after catching a fish or when desiring to use a different lure assembly as the angler desires. For example, U.S. Pat. No. 8,615,920, which is incorporated herein by reference for all useful purposes, and which shares common inventorship with present disclosure, describes such a leaderless quick release fishing assembly.

One drawback of such leaderless quick release fishing assemblies is inadvertent disengagements. As the forces and interaction with the quick release and lure assemblies with a hooked fish occur under water and with rapid, unpredictable movements, the point of failure of such assemblies is very difficult to discover.

Another drawback of such leaderless quick release fishing assemblies is ease of use with a one-handed operation. For example, unless there is tension pulling apart the male and female ends of the quick release assembly when disengaged by movement of the collar, an angler may need to use a second hand to pull the male and female ends apart after the translation of the collar effects disengagement of the quick release assembly. As another example, the collar on such assemblies has a resistance spring when pulling the collar back to open the female end to either insert the male end or disengage a male end. This requires an angler to simultaneously pull back the collar while engaging the male end into the quick release assembly, which can be cumbersome and difficult.

Another drawback of such leaderless quick release fishing assemblies is the incorporation of the body of a lure into the quick release fishing assemblies. For example, many anglers want the ability to use different kinds of lures based on the angler's preferences, the fishing conditions, and the targeted fish. Such a collection of lure assemblies are expensive for angler to invest in, and it is undesired to completely change out an angler's lure collection. Accordingly, a fishing assembly that incorporates a quick release mechanism without integration into the lure itself such that an angler's existing lure collection can be utilized is desired.

In this vein, the present inventors have developed novel improvements to the quick release fishing assembly that has significantly overcome the aforementioned drawbacks and others.

### BRIEF DESCRIPTION OF PREFERRED EMBODIMENTS

A first aspect of the present disclosure includes a fishing assembly including a quick release assembly. The quick release assembly can include a first body having a first end and a second end opposite the first end; a second body having a first end and a second end opposite the first end. The quick release assembly can further include a collar adapted to translate along the first or second body to transition between an engaged configuration and a disengaged configuration. The first end of the first body can be adapted to be coupled to a fishing line, and the first end of the second body can be adapted to be coupled to a hook. The second end of the first body can be adapted to be releasably engagable with the second end of the second body. In certain embodiments, the quick release assembly includes a collar lock which can be adapted to selectively lock the collar in the second configuration.

In further embodiments, the collar lock can include a first channel, a second channel, and a locking pin.

In further embodiments, the collar lock can include a first channel, a second channel, and a locking pin, wherein the first channel is disposed at an angle from the second channel, and wherein the first channel and second channel can be disposed through the collar.

In further embodiments, the locking pin can further secure a piston biased by a spring within the first body.

In further embodiments, the locking pin can be coupled to the first body and extends through the collar at the first and/or second channels.

Another aspect of the present disclosure is directed to a fishing assembly including a quick release assembly. The quick release assembly can include a first body having a first end and a second end opposite the first end; a second body having a first end and a second end opposite the first end. The quick release assembly can further include a collar adapted to translate along the first or second body to transition between an engaged configuration and a disengaged configuration. The first end of the first body can be adapted to be coupled to a fishing line, and the first end of the second body can be adapted to be coupled to a hook. The second end of the first body can be adapted to be releasably engagable with the second end of the second body. In certain embodiments, the fishing assembly can further include a flange extending radially from the first or second body at the second end of the first or second body, wherein a ratio of the outside diameter of the collar to the outside diameter of the flange can be at least about 1:1.

In further embodiments, the flange can extend radially from the second body.

In further embodiments, the flange can extend radially from the first body in a direction that is generally normal to the direction of travel of the collar when transitioning from the second configuration to the first configuration.

In further embodiments, the flange can be integral with the first or second body.

In further embodiments, the flange can be adapted to reduce the frequency of inadvertent transitions from the second configuration to the first configuration.

In further embodiments, the collar can have a first edge disposed nearest the second end of the first body or second body, and the flange can be adapted to protect the first edge of the collar from inadvertent disengagements.

Another aspect of the present disclosure includes a fishing assembly including a quick release assembly. The quick release assembly can include a first body having a first end and a second end opposite the first end; a second body having a first end and a second end opposite the first end. The quick release assembly can further include a collar adapted to translate along the first or second body to transition between an engaged configuration and a disengaged configuration. The first end of the first body can be adapted to be coupled to a fishing line, and the first end of the second body can be adapted to be coupled to a hook. The second end of the first body can be adapted to be releasably engagable with the second end of the second body. In certain embodiments, the quick release assembly can be adapted to engage the first and second body without simultaneously transitioning the first body to an engagable position.

In further embodiments, the quick release assembly can be adapted to translate the collar towards the second end of the first or second body when the second body is engaged with the first body without manipulation of the collar by a user.

In further embodiments, the quick release assembly can include a ball bearing.

In further embodiments, the quick release assembly can include a ball bearing, a plurality of openings adapted to receive the ball bearings, and a piston biased towards the second end of the first body by a spring.

In further embodiments, the ball bearings can engage with a first race disposed on the collar in the engaged configuration, and wherein the ball bearing engages with a second race disposed on the collar in the disengaged configuration, and wherein the second race is disposed further from the center axis of the first body than the first race.

In further embodiments, the ball bearings can engage with a first race disposed on the collar in the engaged configuration, and the ball bearings can engage with a second race disposed on the collar in the disengaged configuration, and wherein the second race can be disposed radially further from the center axis of the first body than the first race, and wherein the second race can be disposed nearer the second end of the first body than the first race.

Yet another aspect of the present disclosure includes a fishing assembly including a quick release assembly. The quick release assembly can include a first body having a first end and a second end opposite the first end; a second body having a first end and a second end opposite the first end. The quick release assembly can further include a collar adapted to translate along the first or second body to transition between an engaged configuration and a disengaged configuration. The first end of the first body can be adapted to be coupled to a fishing line, and the first end of the second body can be adapted to be coupled to a hook. The second end of the first body can be adapted to be releasably engagable with the second end of the second body. In certain embodiments, the quick release assembly can be adapted to eject the second body from the first body when transitioning from the engaged configuration to the disengaged configuration.

In further embodiments, the first body can include a piston biased by a spring towards the second end of the first body.

In further embodiments, the piston can be adapted to eject second body from the first body when transitioning from the engaged configuration to the disengaged configuration.

In further embodiments, the piston can be adapted to eject the second body from the first body when the collar is urged towards the first end of the second body.

In further embodiments, the first body can further include a plurality of ball bearings and a plurality of openings adapted to receive the ball bearings, and wherein the quick release assembly is adapted to transition the ball bearings radially outwardly from the center axis of the first body through movement of the collar toward the first end of the first body.

In further embodiments, the quick release assembly can be adapted to transition the ball bearings radially inwardly towards the center axis of the first body through engagement of the second body with the piston and compression of the spring biasing the piston towards the second end of the first body.

### BRIEF DESCRIPTION OF THE DRAWINGS

Embodiments are illustrated by way of example and are not limited in the accompanying figures.

FIG. 1 includes an illustration of a fishing assembly according to an embodiment.

FIG. 2 includes an exploded perspective illustration of a quick release assembly according to an embodiment.

FIG. 3 includes a cross-section illustration of an assembled quick release in a disengaged configuration according to an embodiment.

FIG. 4 includes a cross section illustration of an assembled quick release assembly in an engaged configuration according to an embodiment.

FIG. 5 includes a side illustration of a quick release mechanism and a collar lock in a disengaged configuration according to an embodiment.

FIG. 6 includes a side illustration of a quick release assembly and a collar lock in an engaged and unlocked configuration according to an embodiment.

FIG. 7 includes a side illustration of a quick release assembly and a collar lock in an engaged and locked configuration according to an embodiment.

FIG. 8 includes a cross-section illustration of a second body of a quick release assembly according to an embodiment.

FIG. 9 includes a side illustration of a second body of a quick release assembly according to an embodiment.

FIG. 10 includes a perspective illustration of a fishing assembly with a quick release assembly that is not integral with a lure according to an embodiment.

FIG. 11 includes a side illustration of a fishing assembly having a radially movable locking pin according to an embodiment in an engaged or locked configuration.

FIG. 12 includes a side illustration of a fishing assembly having a radially movable locking pin according to an embodiment in a transitory configuration.

FIG. 13 includes a side illustration of a fishing assembly having a radially movable locking pin according to an embodiment in a disengaged configuration.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the fishing arts.

The present disclosure is directed to quick release fishing assemblies exhibiting improved performances in, for example, ease of handling and reduced inadvertent disengagements. The concepts are better understood in view of the embodiments described below that illustrate and do not limit the scope of the present disclosure.

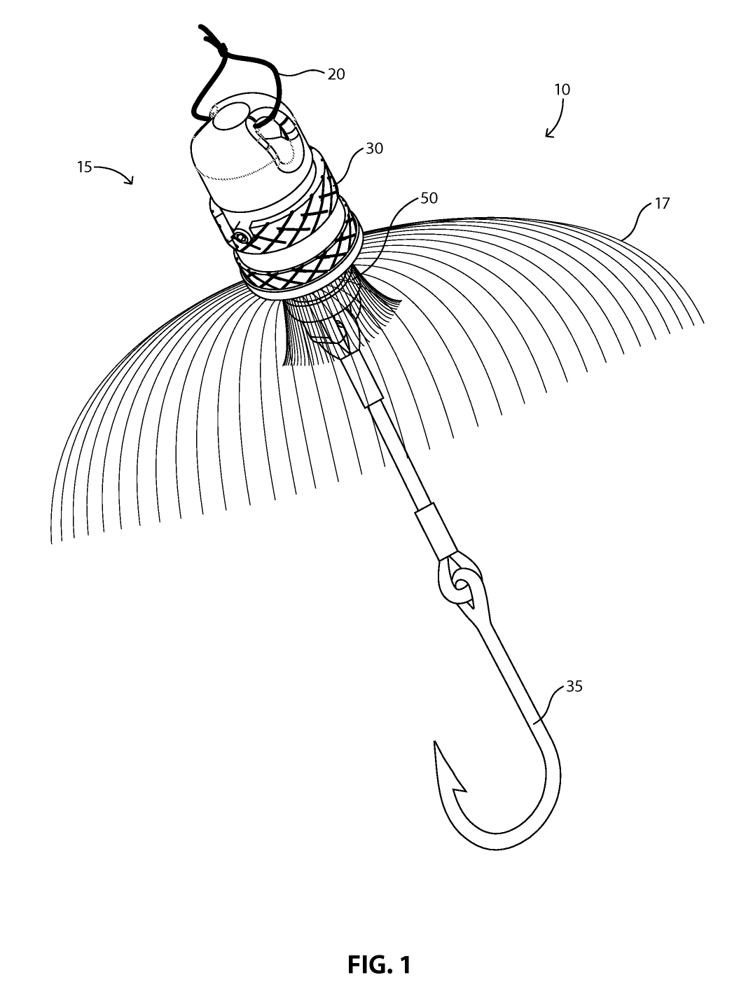

Referring now to FIG. 1, there is illustrated a fishing assembly 10 according to certain embodiments. In general, the fishing assembly 10 can include a fishing line 20, a quick release assembly 30, and a hook 35.

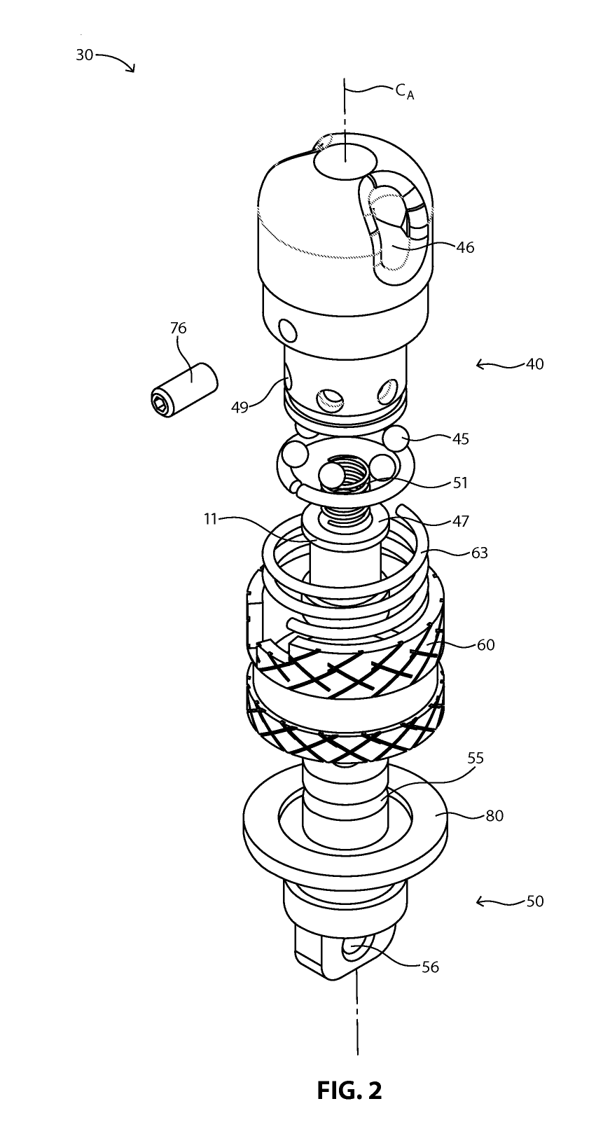

Referring now to FIG. 2, there is illustrated an enlarged exploded perspective view of a quick release assembly 30 according to certain embodiments. The quick release assembly 30 can generally include a first body 40 and a second body 50 that are adapted to be releaseably engagable with each other.

Referring now to FIGS. 2-4, the first body 40 can have a first end 42 and a second end 44 opposite the first end 42. The first end 42 of the first body 40 can be adapted to be coupled to a fishing line. For example, the first body can include an eyelet 46 which a fishing line can be threaded through and tied to secure the first body 40 to the fishing line.

The second body 50 can have a first end 52 and a second end 54 opposite the first end 52. The first end 52 of the second body 50 can be adapted to be coupled to a hook. For example, the first end 52 of the second body can include an eyelet 56 which a hook (via a fishing line or other engagement structure) can be threaded through to secure the second body 50 to a hook or other lure assembly comprising a hook or other lure systems or components.

The second end 44 of the first body 40 and the second end 54 of the second body 50 can be adapted to be releasably engagable with each other.

The first body can further include a plurality of openings 49 and a plurality of ball bearings 45 disposed in the openings 49. Further, the first body 40 can include a piston 47 disposed about the center axis C_{A} of the first body 40 and retained within the first body 40 when assembled. Still further, the first body 40 can include a collar 60 adapted to effect transition between engaged and disengaged configurations.

The piston 47 can be adapted to interact with the ball bearings 45. For example, the quick release assembly 30 can include a spring 51 biasing the piston 47 towards the second end 44 of the first body 40 when installed within the first body 40.

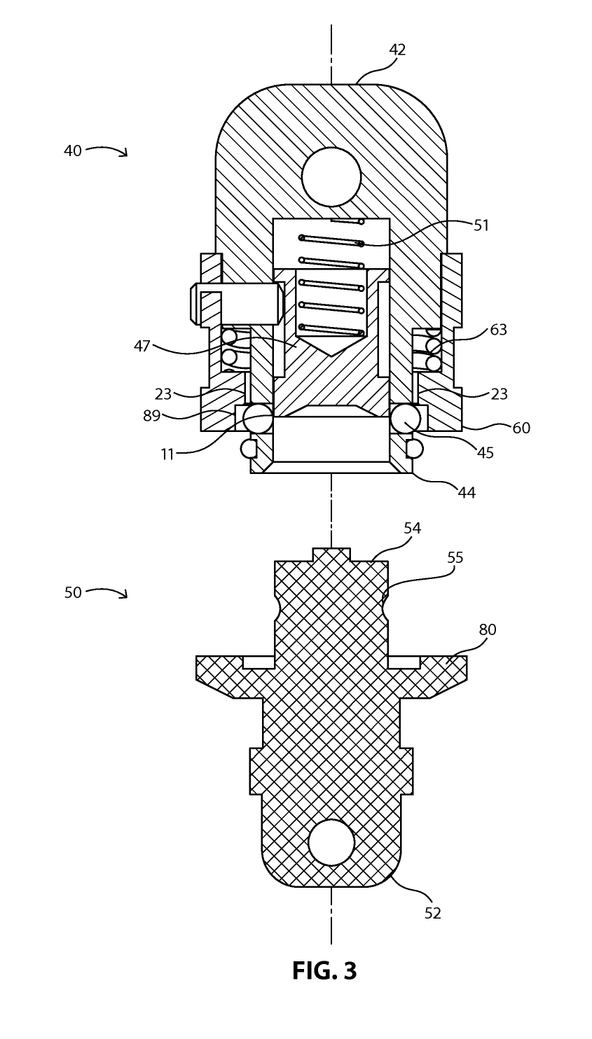

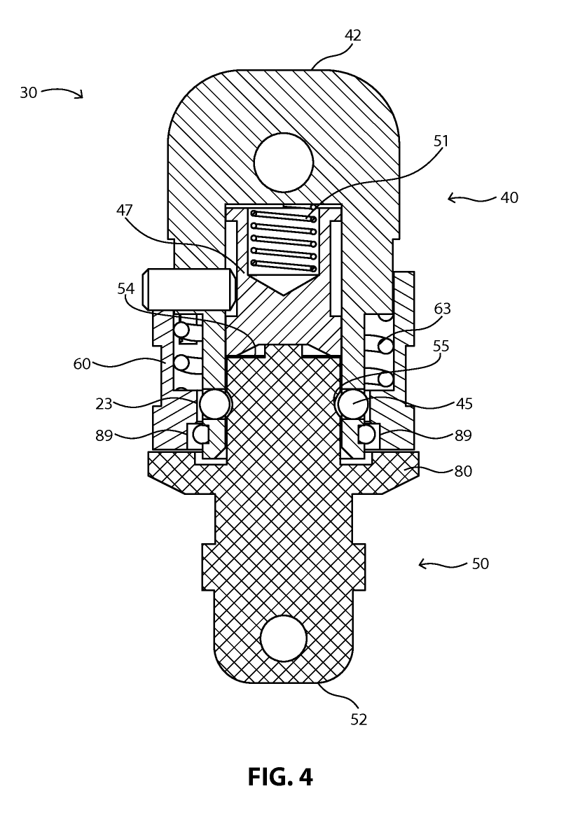

As particularly illustrated in FIGS. 3-4, when the first body 40 is engaged with the second body 50, the second end 54 of the second body 50 can contact the piston 47 and urge the piston 47 towards the first end 42 of the first body 40 thereby compressing the spring 39. In so doing, the ball bearings 45 can be released from engagement with the race 11 on the piston 47 and engaged with the race 55 on the second body 50. During the same transition, the ball bearings 45 can be released from engagement with the race 23 on the collar 60, and the collar 60 can snap towards the second end 44 and thereby lock the ball bearings 45 into engagement with the race 55 on the second body 50, which locks the second body 50 and the first body 40 together.

As discussed above, the second body 50 can include a race 55 adapted to interact with the ball bearings 45 within the first body 40 when in the engaged configuration. For example, as the second body 50 is inserted into the first body 40 and engaged with the piston 47, the piston 47 can be pushed toward the first end 42 of the first body 40, compressing the spring 51. In so doing, the ball bearings 45 are no longer urged radially outward by the piston 47, and the ball bearings 45 travel towards the center axis C_{A}. As such, the collar 60, which is being biased towards the second end 44 of the first body 40 by the spring, is no longer resisted from translating toward the second end 44 by the ball bearings 45. Accordingly, the collar 60 snaps towards the second end 44 of the first body 40 and sandwiches the ball bearing 45 between the collar 60 and the race 55 on the second body 50.

Referring again to FIGS. 3-4, the quick release assembly 30 can be adapted to allow engagement of the second body 50 and the first body 40 by pushing the second body 50 into the first body 40 without having to simultaneously urge the collar 60 towards the first end 42. For example, the collar 60 can include a second race 89 disposed radially further from the center axis C_{A} than the first race 23 on the collar 60, thereby forming an internal collar notch which can receive the ball bearings 45 while the piston 47 urges the ball bearings 45 radially away from the center axis C_{A}. For example, when transitioning from the engaged to disengaged configurations (i.e. transitioning from the position illustrated in FIG. 4 to the position illustrated in FIG. 3), the collar 60 can be pulled by an angler towards the second end 44 of the first body 40, and thereby release the resistance of the ball bearings 45 against the first race 23 of the collar 60. In so doing, the ball bearings can be received in the second race 89 of the collar 60. As the second race 89 is spaced further radially from the center axis C_{A} than the first race 23, the ball bearings 45 translate radially outwardly from the center axis C_{A} to engage the second race 89. As such, the ball bearings 45 maintain the collar 60 near the first end 42 of the first body 40 and the spring 63 compressed, and ready for engagement with a second body 50 by pushing a second body 50 without having to simultaneously manipulate the collar 60.

With the locking of the collar towards the first end of the first body when in the disengaged configuration, an Angler can simply insert the second body into the first body without having to manipulate the collar to translate to the engaged configuration. Such an advantage can significantly improve the efficiency, ease, and safety of the fishing assembly operation.

In certain embodiments, the quick release assembly 30 can be adapted to eject the second body 50 from the first body 40 (as opposed to simply releasing the second body 50 from the first body). For example, referring again to FIGS. 2-4, when transitioning from an engaged configuration to a disengaged configuration, the collar 60 is pulled towards the first end 42 of the first body 40. The piston 47 is being biased towards the second end 44 of the first body 40 by the spring 51. As the collar is pulled toward the first end of the first body, ball bearings 45 begin translating radially outward from the center axis C_{A}. The race 55 of the second body 50 is thus no longer engaged with the ball bearings 45, and the first body 40 is disengaged from the second body 50. The piston 47, by force of the expanding spring 51, can thus eject the second body 50 from the first body 40 with a predetermined spring force.

A particular advantage of certain embodiments of the present disclosure is the creation of a fishing assembly which reliably and consistently positively ejects (as opposed to simply releases) the second body from the first body. Such functionality improves an Angler's ability to quickly and safely operate the fishing assembly with one hand, particularly when a fish has been hooked and reeled to the boat.

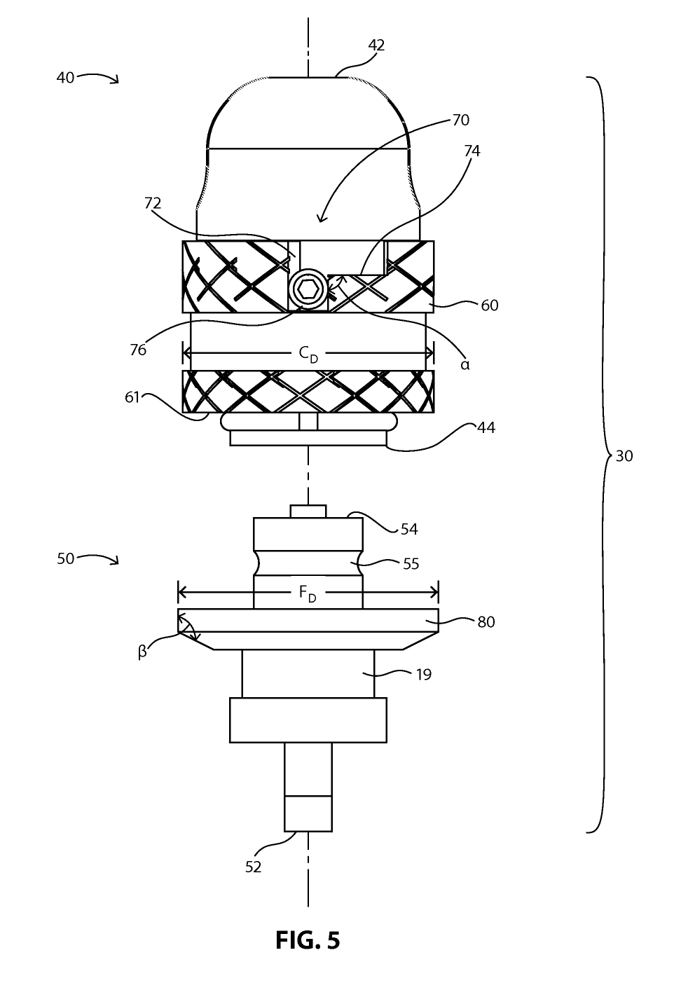

Referring now to FIGS. 5-7, in certain embodiments, the quick release assembly can further include a collar lock assembly adapted to selectively lock the collar in the engaged configuration. For example, the collar lock assembly can include a plurality of channels cut out of the collar and a collar retention member to prevent the collar from transitioning to a disengaged configuration when the collar lock assembly is engaged. In the particular embodiment illustrated in FIGS. 5-7, the collar lock assembly 70 can include a collar 60 having a first channel 72 and a second channel 74, and a locking pin 76.

The first channel 72 can extend at an angle from the second channel 74. For example, the first channel 72 can extend at an angle from the second channel 74 at an angle in a range of from 1 degree to 179 degrees, 1 degree to 90 degrees, or even 45 degrees to 90 degrees. In very particular embodiments, the first channel 72 can extend generally parallel to the center axis of the collar C_{A} and the second channel 74 can extend generally perpendicular to the center axis C_{A} of the collar 60.

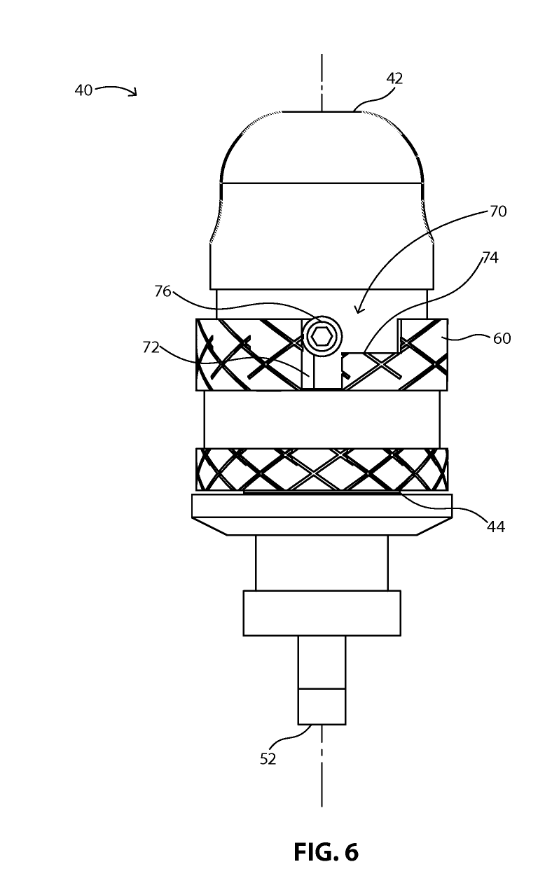

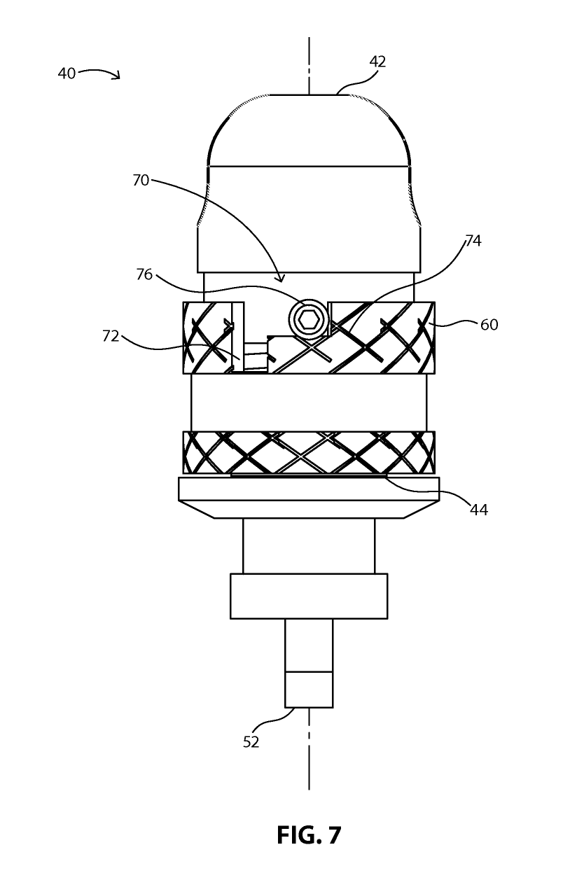

To operate the collar lock, beginning from the disengaged configuration illustrated in FIG. 5, the Angler would insert the second body 50 into the first body 40, thereby causing the collar 60 to translate toward the second end 44 of the first body 40 such that locking pin 76 is disposed in both the first and second channels 72, 74 as illustrated in FIG. 6. Next, the angler would rotate the collar 60 such that locking pin 76 was no longer aligned within the first channel 72 as illustrated in FIG. 7. In the locked configuration, the collar 60 is prevented by the locking pin 76 from translating toward the first end 42 of the first body 40 to initiate disengagement.

The collar lock assembly provides significant advantages to the reliability and efficiency of the fishing assembly. For example, with the embodiments of the collar lock described above, inadvertent disengagements can be essentially eliminated. Another advantage of the collar lock assembly in combination with the ability for the collar to stay nearer the first end in the engaged configuration is that an Angler does not have to rotate the collar or otherwise operate the collar lock when engaging the first body and the second body.

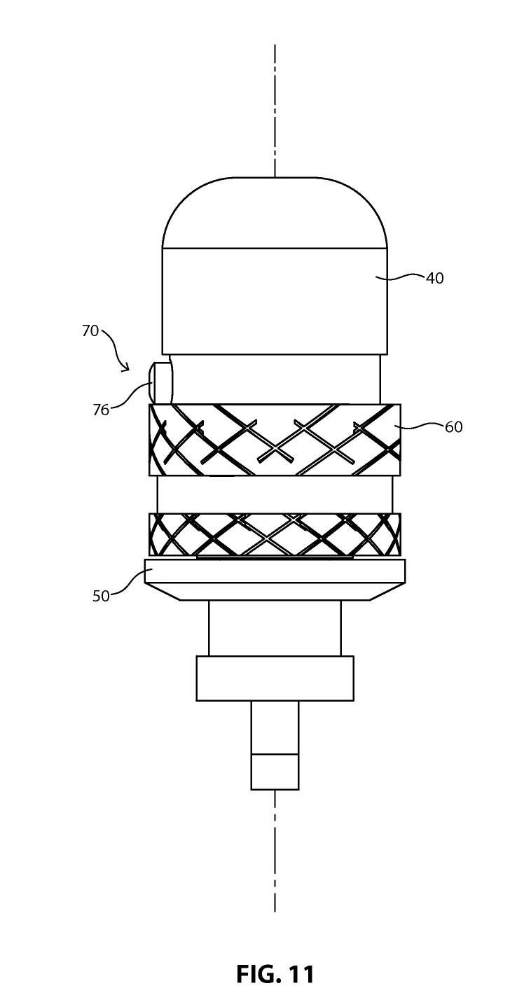

In other embodiments, and referring in particular to FIGS. 11-13, the collar lock assembly 70 can include a locking pin 76 that is movable in a radial direction from the first body 40. For example, the collar lock assembly can include a spring (not pictured) that urges the locking pin 76 radially outwardly.

As such, starting from an engaged position as illustrated in the side view of FIG. 11, a user can push the locking pin 76 radially inwardly, thereby allowing the collar 60 to move away from the second body 50. As discussed herein, movement of the collar 60 away from the second body 50 causes disengagement of the assembly.

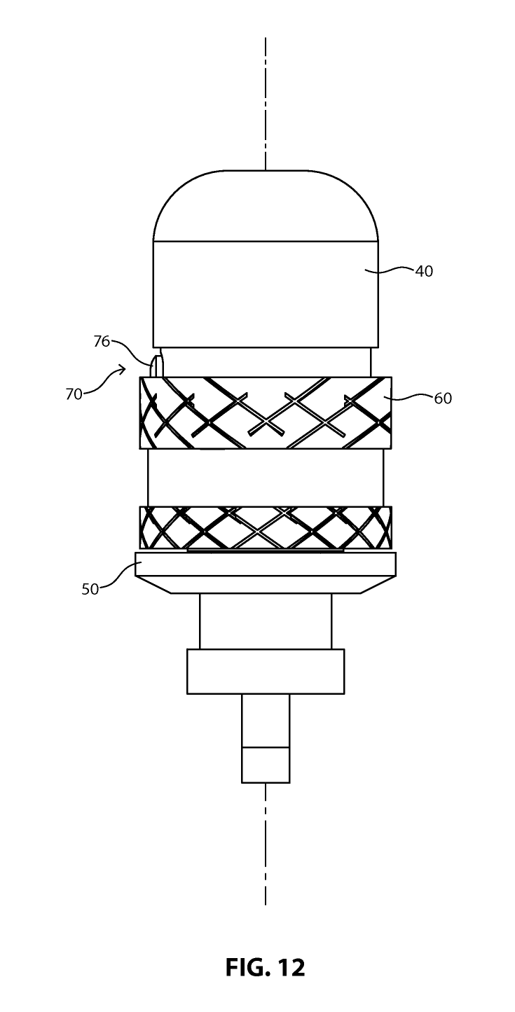

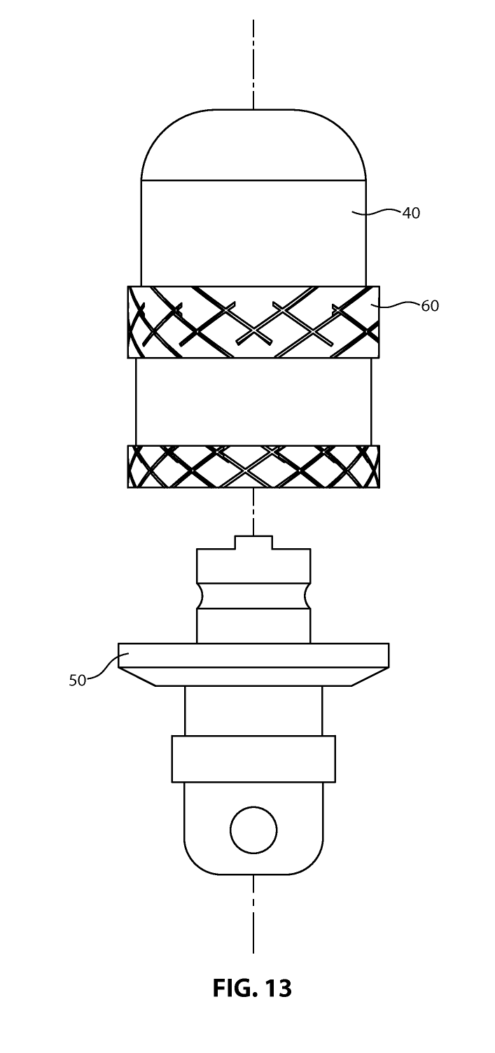

FIG. 12, illustrates a partially depressed locking pin 76 and a partially moved collar 60, and FIG. 13 illustrates a fully depressed locking pin 76 and a fully moved collar 60 thereby causing the disengagement of the first body 40 and the second body 50.

In this way, the assembly is protected from inadvertent disengagement caused by, for example, a hooked fish. In such embodiments, it is to be understood that the channels described above in relation to FIGS. 5-7 disposed on the collar are not necessary.

Referring again in particular to FIGS. 3-5, in certain embodiments, the quick release assembly 30 can further include a flange 80 adapted to protect the collar edge 61 nearest the second end 44 of the first body 40. The flange 80 can extend radially from the second body 50 near the second end 54 of the second body 50.

In certain embodiments, the flange 80 can be in a non-translational relationship with the collar 60, such that forces interacting with the flange 80 do not urge the collar toward its disengaged configuration, i.e. toward the first end 42 of the first body 40. For example, the flange 80 can be integral with the second body 50.

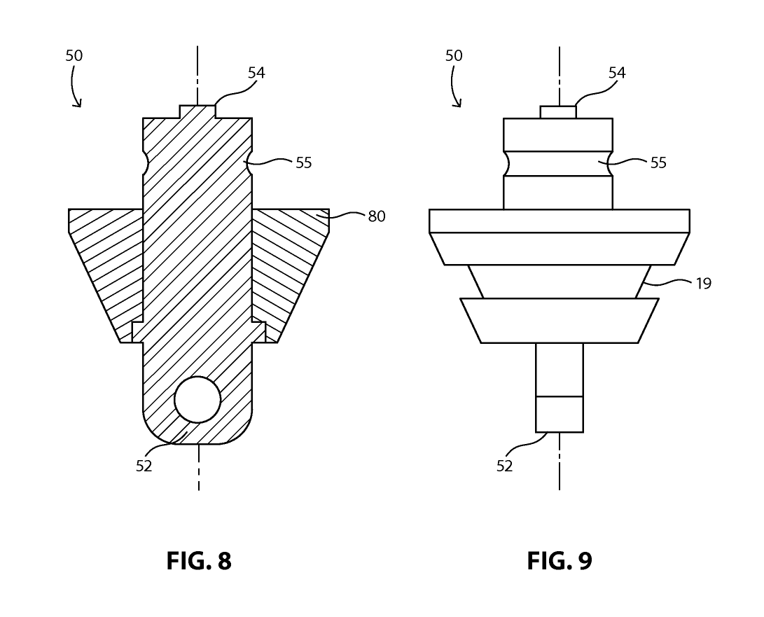

In other embodiments, as particularly illustrated in FIG. 8, the flange 80 can be a separate piece from the first body and the second body. In such embodiments, the flange 80 can be made of the same or a different material. In particular embodiments, the flange 80 can be made of a different material. For example, the flange 80 can be made of a polymer material, while the second body 50 can be made of a metal, particularly a corrosion resistant metal such as stainless steel.

In further embodiments, as illustrated in FIG. 5, the flange 80 can have a generally disc or cylindrical shape. Further, in certain embodiments, at least a portion of the flange 80 can have a tapered outer profile extending from the edge of the flange 80 nearest the second end 44 towards the first end 46 of the first body 40. The tapered surface can extend at an angel β from the flange 80 edge surface at a desired angle β. For example, the flange can extend from the flange surface at an angle β in a range of from 90 degrees to 179 degrees, from 95 degrees to 170 degrees, or even from 110 degrees to 140 degrees.

In certain embodiments, as illustrated in FIG. 5, the collar 60 can have a longest diameter C_{D} and the flange 80 can have a longest diameter F_{D}. A ratio of the longest diameter of the flange to the longest diameter of the collar can be in a range of from 0.1:1 to 10:1, 0.5:1 to 1.5:1, 0.75:1 to 1.25:1, or even 0.9:1 to 1.1:1. In particular embodiments, a ratio of the longest diameter of the flange to the longest diameter of the collar can be at least about 1:1.

A particular advantage of a collar protecting flange as described herein is to protect the collar 60 from inadvertent disengagements by blocking access to the edge surface 61 of the collar 60 nearest the second end 54. For example, without such a flange protecting the collar edge 61, force can be exerted to the collar edge 61 and inadvertently disengage the quick release assembly 30. Such forces can occur by, for example, force from the bill of a hooked fish, or force caused by interaction with water, or with other debris in the water. The protective collar flange can therefore mitigate the risk of inadvertent disengagement by impeding forces from interacting with the edge surface 61 of the collar 60. Moreover, such a collar protecting flange can further protect the internal components of the quick release assembly from foreign debris when the quick release assembly is in use.

Another aspect of the present disclosure is directed to a fishing assembly comprising any of the embodiments of the quick release assembly 30 described herein and a lure 15.

In certain embodiments, at least a portion of the quick release assembly can be integrated with the lure 15. For example, as illustrated in FIG. 1, the second body 50 of the quick release assembly 30 can form a body of the lure. The lure can further include a skirt 17 and a hook 35. The skirt 17 can be connected to the second body 50 of the quick release assembly 30, which can thereby help to conceal at least a portion of the quick release assembly 30 and/or hook 35 and help to attract a targeted fish. In particular embodiments, the fishing assembly 10 can further include a skirt coupling structure. For example, as illustrated in FIGS. 5 and 9, the second body can include a skirt groove 19, and an elastic band (not shown) adapted to be disposed on the groove 19 and can be used to locate and secure a skirt (not shown) to second body 50.

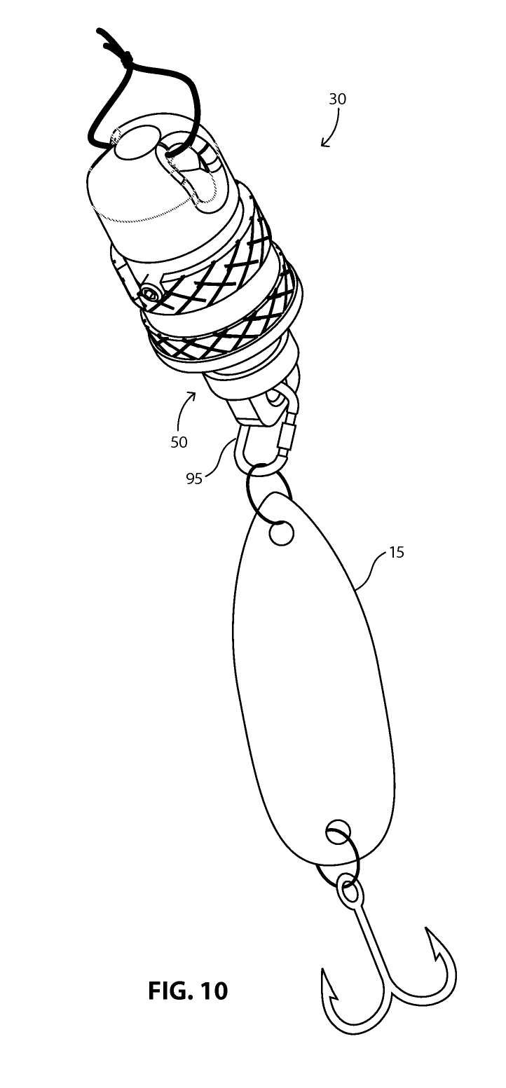

In other embodiments, the second body 50 can be adapted to indirectly couple to the lure 15 such that the second body 50 (or any other direct component of the quick release assembly 30) does not form an integral component of the lure 15 itself. For example, as illustrated in FIG. 10, the lure can be coupled to the first end of the second body with a carbineer 95 type coupling. In such an embodiment, the quick release mechanism 30 does not form an integral piece of the lure 15, but is rather coupled to a lure 15. It is to be understood that any suitable coupling mechanism between a lure and the first end of the second body can be employed. Regardless of the particular coupling mechanism used, the fishing assembly, and particularly the quick release assembly, can be adapted for use with an Angler's existing lure collection.

The present disclosure represents a departure from the state of the art. Particular embodiments of the fishing assembly described herein have significantly improved handling and elimination of inadvertent disengagements of quick release fishing assemblies. As examples, the present disclosure describes certain embodiments that include a locking collar mechanism and a protective collar flange that serve to virtually eliminate inadvertent disengagements of the quick release assembly due to forces which can occur during fishing. Moreover, certain embodiments describe features such as a push to engage system and a spring forced ejection during disengagement that has significantly improved the handling of the quick release fishing assembly. Still further, certain embodiments describe features that enable an Angler to transform an existing lure collection into a quick release lure collection. These examples of certain advantages, individually, and in any combination, unexpectedly provided significantly improved fishing assemblies.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. For example, as described herein, the first body includes the female end and the second body includes the male end, but it is entirely within the scope of the present disclosure to have the first body include the male end and the second body include the female end. Further, as described herein, the collar is disposed on the first body, but, in other embodiments, could be disposed on the second body. Accordingly, the disclosure is to be regarded as illustrative rather than restrictive.

What is claimed is:

1. A fishing assembly comprising:
a quick release assembly comprising: a first body having a first end and a second end opposite the first end; a second body having a first end and a second end opposite the first end; a collar adapted to translate along the first or second body to transition between an engaged configuration and a disengaged configuration; and
wherein the first end of the first body is adapted to be coupled to a fishing line, wherein the first end of the second body is adapted to be coupled to a hook, and wherein the second end of the first body is adapted to be releasably engagable with the second end of the second body; and
wherein the quick release assembly comprises a collar lock which is adapted to selectively lock the collar in the second configuration.

2. The fishing assembly of claim 1, wherein the collar lock comprises a first channel, a second channel, and a locking pin.

3. The fishing assembly of claim 1, wherein the collar lock comprises a first channel, a second channel, and a locking pin, wherein the first channel is disposed at an angle from the second channel, and wherein the first channel and second channel are disposed through the collar.

4. The fishing assembly of claim 3, wherein the locking pin further secures a piston biased by a spring within the first body.

5. The fishing assembly of claim 3, wherein the locking pin is coupled to the first body and extends through the collar at the first and/or second channels.

6. A fishing assembly comprising:
a quick release assembly comprising: a first body having a first end and a second end opposite the first end; a second body having a first end and a second end opposite the first end; a collar adapted to translate along the first or second body to transition between an engaged configuration and a disengaged configuration; and a flange extending radially from the first or second body at the second end of the first or second body, wherein a ratio of the outside diameter of the collar to the outside diameter of the flange is at least about 1:1; and
wherein the first end of the first body is adapted to be coupled to a fishing line, wherein the first end of the second body is adapted to be coupled to a hook, and wherein the second end of the first body is adapted to be releasably engagable with the second end of the second body.

7. The fishing assembly of claim 6, wherein the flange extends radially from the second body.

8. The fishing assembly of claim 6, wherein the flange extends radially from the first body in a direction that is generally normal to the direction of travel of the collar when transitioning from the second configuration to the first configuration.

9. The fishing assembly of claim 6, wherein flange is integral with the first or second body.

10. The fishing assembly of claim 6, wherein the flange is adapted to reduce the frequency of inadvertent transitions from the second configuration to the first configuration.

11. The fishing assembly of claim 6, wherein the collar has a first edge disposed nearest the second end of the first body or second body, and wherein the flange is adapted to protect the first edge of the collar from inadvertent disengagements.

12. A fishing assembly comprising:
a quick release assembly comprising: a first body having a first end and a second end opposite the first end; a second body having a first end and a second end opposite the first end; a collar adapted to translate along the first or second body to transition between an engaged configuration and a disengaged configuration; and
wherein the first end of the first body is adapted to be coupled to a fishing line, wherein the first end of the second body is adapted to be coupled to a hook, and wherein the second end of the first body is adapted to be releasably engagable with the second end of the second body; and
wherein the quick release assembly is adapted to engage the first and second body without simultaneously transitioning the first body to an engagable position.

13. The fishing assembly of claim 12, wherein the quick release assembly is adapted to translate the collar towards the second end of the first or second body when the second body is engaged with the first body without manipulation of the collar by a user.

14. The fishing assembly of claim 12, wherein the quick release assembly comprises a ball bearing.

15. The fishing assembly of claim 12, wherein the quick release assembly comprises a ball bearing, wherein the first body comprises a plurality of openings adapted to receive the ball bearings, and wherein the first body comprises a piston biased towards the second end of the first body by a spring.

16. The fishing assembly of claim 12, wherein the ball bearing engages with a first race disposed on the collar in the engaged configuration, and wherein the ball bearing engages with a second race disposed on the collar in the disengaged configuration, and wherein the second race is disposed further from the center axis of the first body than the first race.

17. The fishing assembly of claim 12, wherein the ball bearing engages with a first race disposed on the collar in the engaged configuration, and wherein the ball bearing engages with a second race disposed on the collar in the disengaged configuration, and wherein the second race is disposed radially further from the center axis of the first body than the first race, and wherein the second race is disposed nearer the second end of the first body than the first race.

18. A fishing assembly comprising:
a quick release assembly comprising: a first body having a first end and a second end opposite the first end; a second body having a first end and a second end opposite the first end; a collar adapted to translate along the first or second body to transition between an engaged configuration and a disengaged configuration; and
wherein the first end of the first body is adapted to be coupled to a fishing line, wherein the first end of the second body is adapted to be coupled to a hook, and wherein the second end of the first body is adapted to be releasably engagable with the second end of the second body; and
wherein the quick release assembly is adapted to eject the second body from the first body when transitioning from the engaged configuration to the disengaged configuration.

19. The fishing assembly of claim 18, wherein the first body comprises a piston biased by a spring towards the second end of the first body.

20. The fishing assembly of claim 18, wherein the piston is adapted to eject second body from the first body when transitioning from the engaged configuration to the disengaged configuration

21. The fishing assembly of claim 18, wherein the piston is adapted to eject the second body from the first body when the collar is urged towards the first end of the second body.

22. The fishing assembly of claim 21, wherein the first body further comprises a plurality of ball bearings and a plurality of openings adapted to receive the ball bearings, and wherein the quick release assembly is adapted to transition the ball bearings radially outwardly from the center axis of the first body through movement of the collar toward the first end of the first body.

23. The fishing assembly of claim 22, wherein the quick release assembly is adapted to transition the ball bearings radially inwardly towards the center axis of the first body through engagement of the second body with the piston and compression of the spring biasing the piston towards the second end of the first body.

24. The fishing assembly of claim 1, wherein the collar lock comprises a locking pin that extends radially past an edge of collar closest to a center axis of the first body in an engaged configuration, and is movable in a radial direction from the first body to effect disengagement.

25. The fishing assembly of claim 1, wherein the collar lock comprises a locking pin that extends radially past an edge of collar closest to a center axis of the first body in an engaged configuration, and wherein the locking pin is adapted to prevent the collar from disengaging unless the locking pin is depressed past the collar.
